(19) United States
(12) Patent Application Publication
(10) Pub. No.: US 2025/0052876 A1
(43) Pub. Date: Feb. 13, 2025

(54) DISTANCE MEASURING SYSTEM AND METHOD USING PHYSICALLY OFFSET TRANSDUCERS

(71) Applicant: SAUDI ARABIAN OIL COMPANY, Dhahran (SA)

(72) Inventors: Abubaker Saeed, Dhahran (SA); Boleslaw Mellerowicz, Brooklyn, NY (US)

(73) Assignee: SAUDI ARABIAN OIL COMPANY, Dhahran (SA)

(21) Appl. No.: 18/446,263

(22) Filed: Aug. 8, 2023

(51) Int. Cl. G01S 7/527; G01S 15/12

(52) U.S. Cl. CPC G01S 7/5273; G01S 15/12; B64C 39/024

(57) ABSTRACT

A system and method measure distances using physically offset transducers. The system includes first and second transducers physically offset by a predetermined offset distance for generating time-of-flight values of sonic pulses from the transducers to an object. A processor determines a speed of sound in a medium from the time-of-flight values and the offset distance, and determines a distance of at least one of the transducers from the object using the speed of sound and a corresponding time-of-flight value. A controller generates a control signal from the determined distance to control movement of a mobile device. A method implements the system.

### FIELD OF THE DISCLOSURE

The present disclosure relates generally to the measuring of distances, and, more particularly, to a system and method configured to measure distances using physically offset transducers.

### BACKGROUND OF THE DISCLOSURE

Sound navigation and ranging, or sonic navigation and ranging (SONAR) is a technique for measuring distances, such as in underwater environments. To measure the distance to an object, the time from transmission of a sonic pulse to reception of an echo of the sonic pulse is measured and converted into a range using a known speed of sound. However, the speed of sound can vary greatly depending on the medium through which such sonic pulses are propagated. Accordingly, SONAR can be unreliable in instances when a mobile device, such as a submarine, travels through different media having different or unknown values for the speed of sound in each medium.

For example, in the field of oil and gas exploration, a mobile wellhead or an autonomous robot can travel from an air environment above ground and underground to a gaseous or liquid environment underground. The gaseous environment can be an underground pocket of natural gas or a quantity of natural gas passing through a wellbore. The liquid environment can be petroleum passing through a wellbore. Therefore, to measure distances in such diverse environments, it is important to determine the speed of sound in the environments in which a mobile device passes.

### SUMMARY OF THE DISCLOSURE

According to an embodiment consistent with the present disclosure, a system and method measure distances using physically offset transducers.

In an embodiment, a system comprises a first transducer, a second transducer, a processor, and a controller. The first transducer is configured to transmit a first sonic pulse in a first direction towards an object, to receive a first echo of the first sonic pulse from the object, and to generate a first time-of-flight value A of the first sonic pulse. The second transducer is configured to transmit a second sonic pulse in the first direction towards the object, to receive a second echo of the second sonic pulse from the object, and to generate a second time-of-flight value B of the second sonic pulse. The second transducer is physically offset from the first transducer by an offset distance Δd along the first direction. The processor includes code executed therein configured to receive the first time-of-flight value A and the second time-of-flight value B, to generate a speed-of-sound value S, and to determine a distance value D of the object from at least one of the first and second transducers using the speed-of-sound value S and at least one of the first time-of-flight value A and the second time-of-flight value B, respectively. The controller is configured to receive the distance value D, and is responsive to the distance value D to generate a control signal to control movement of a mobile device.

The mobile device can include the controller. Alternatively, the controller can be external to the mobile device. The speed-of-sound value S can correspond to the speed of sound of a medium in an environment of the mobile device. The processor can be configured to determine the speed-of-sound value S according to S=Δd/|A−B|, wherein the value |A−B| is the absolute value of a difference of the first time-of-flight value A and the second time-of-flight value B. The processor can be configured to determine the distance D according to D=S×A when A>B. Alternatively, the processor can be configured to determine the distance D according to D=S×B when B>A. The first and second transducers can be spaced apart by a length L in a second direction perpendicular to the first direction.

In another embodiment, a mobile device comprising a chassis, a propulsion system, a first transducer, a second transducer, and a processor. The propulsion subsystem has an end section and is configured, responsive to a control signal, to propel the chassis in a first direction. The first transducer is disposed in the end section and is configured to transmit a first sonic pulse in a first direction towards an object, to receive a first echo of the first sonic pulse from the object, and to generate a first time-of-flight value A of the first sonic pulse. The second transducer is disposed in the end section configured to transmit a second sonic pulse in the first direction towards the object, to receive a second echo of the second sonic pulse from the object, and to generate a second time-of-flight value B of the second sonic pulse. The second transducer is physically offset from the first transducer by an offset distance Δd along the first direction. The processor includes code executed therein configured to receive the first time-of-flight value A and the second time-of-flight value B, to generate a speed-of-sound value S, and to determine a distance value D of the object from at least one of the first and second transducers using the speed-of-sound value S and at least one of the first time-of-flight value A and the second time-of-flight value B, respectively. The controller is configured to receive the distance value D, and is responsive to the distance value D to generate the control signal to control movement of a mobile device by the propulsion subsystem.

The chassis can include the controller. Alternatively, the controller can be external to the chassis. The speed-of-sound value S can correspond to the speed of sound of a medium in an environment of the mobile device. The processor can be configured to determine the speed-of-sound value S according to S=Δd/|A−B|, wherein the value |A−B| is the absolute value of a difference of the first time-of-flight value A and the second time-of-flight value B. The processor can be configured to determine the distance D according to D=S×A, wherein A>B. Alternatively, the processor can be configured to determine the distance D according to D=S×B, wherein B>A. The first and second transducers can be spaced apart in the end section by a length L in a second direction perpendicular to the first direction.

In a further embodiment, a method comprises providing a processor, a first transducer, and a second transducer physically offset from the first transducer by an offset distance Δd along a first direction. The method further comprises transmitting a first sonic pulse in the first direction towards an object using the first transducer, receiving a first echo of the first sonic pulse from the object at the first transducer, generating a first time-of-flight value A of the first sonic pulse using the first transducer, transmitting the first time-of-flight value A to the processor, transmitting a second sonic pulse in the first direction towards the object using the second transducer, receiving a second echo of the second sonic pulse from the object at the second transducer, generating a second time-of-flight value B of the second sonic pulse using the second transducer, transmitting the second time-of-flight value B to the processor, receiving the first time-of-flight value A and the second time-of-flight value B at the processor, and generating a speed-of-sound value S from the first time-of-flight value A, the second time-of-flight value B, and the offset distance Δd. The method further comprises determining a distance value D of the object from at least one of the first and second transducers using the speed-of-sound value S and at least one of the first time-of-flight value A and the second time-of-flight value B, respectively. The method also comprises transmitting the distance value D, and receiving the distance value D at a controller. The method further comprises, responsive to the distance value D, generating a control signal using the controller, and responsive to the control signal, controlling movement of a mobile device.

The speed-of-sound value S can correspond to the speed of sound of a medium in an environment of the mobile device. The determining of a distance value D of the object further comprises determining the distance value D according to S=Δd/|A−B|, wherein the value |A−B| is the absolute value of a difference of the first time-of-flight value A and the second time-of-flight value B. The mobile device can include the processor, the first transducer, and the second transducer.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic of a mobile device having physically offset transducers, according to an embodiment.

FIG. 2 is a schematic of an alternative embodiment of the mobile device of FIG. 1.

FIG. 3 is a top front side view of an autonomous mobile platform with a sensor module having offset transducers.

FIG. 4 is an enlarged view of the sensor module of FIG. 3 along lines 4-4.

FIG. 5 is a top front side view of an unmanned aerial vehicle (UAV) having offset transducers.

FIG. 6 is a bottom view of a base of the UAV of FIG. 5.

FIG. 7 is a top front side view of a submarine having physically offset transducers.

FIGS. 8A-8B is a flowchart of a method of operation of the mobile devices of FIGS. 1-2.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system and method configured to measure distances using physically offset transducers.

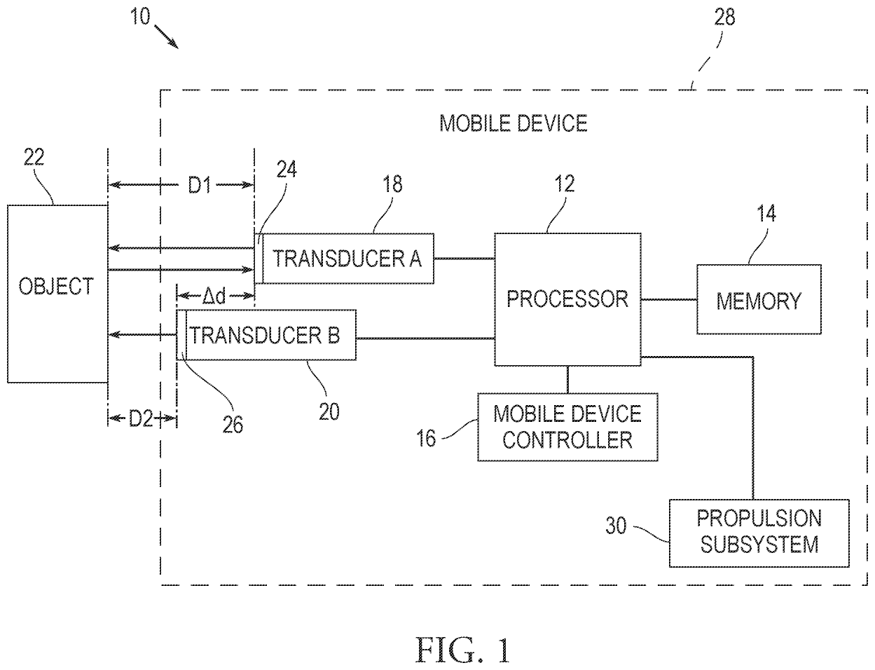

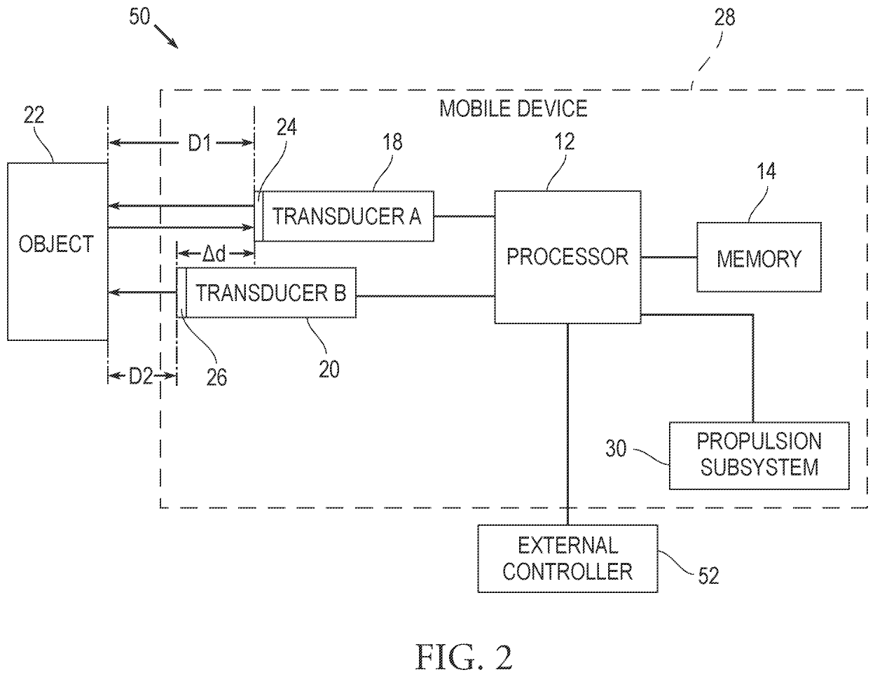

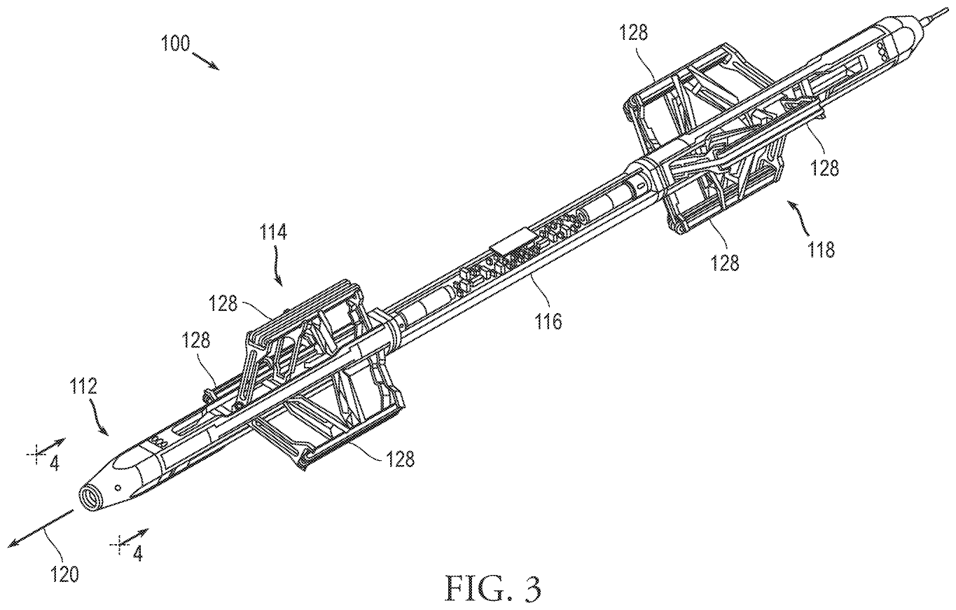

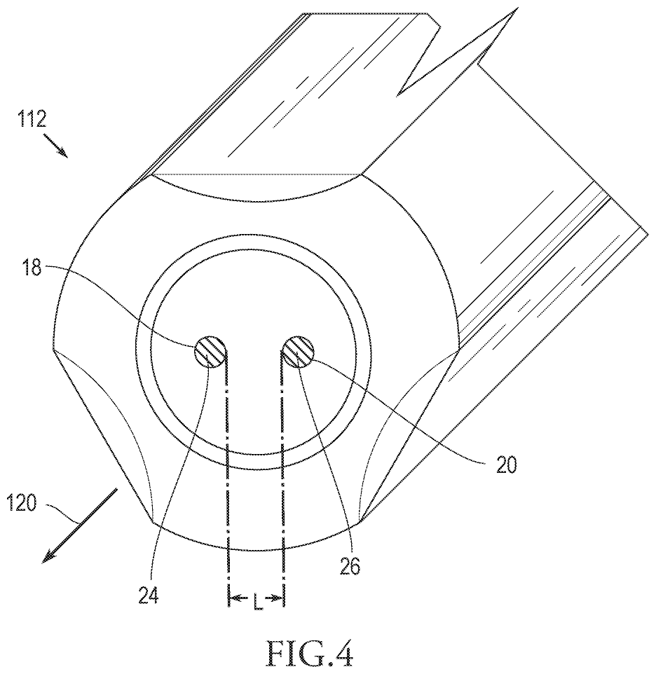

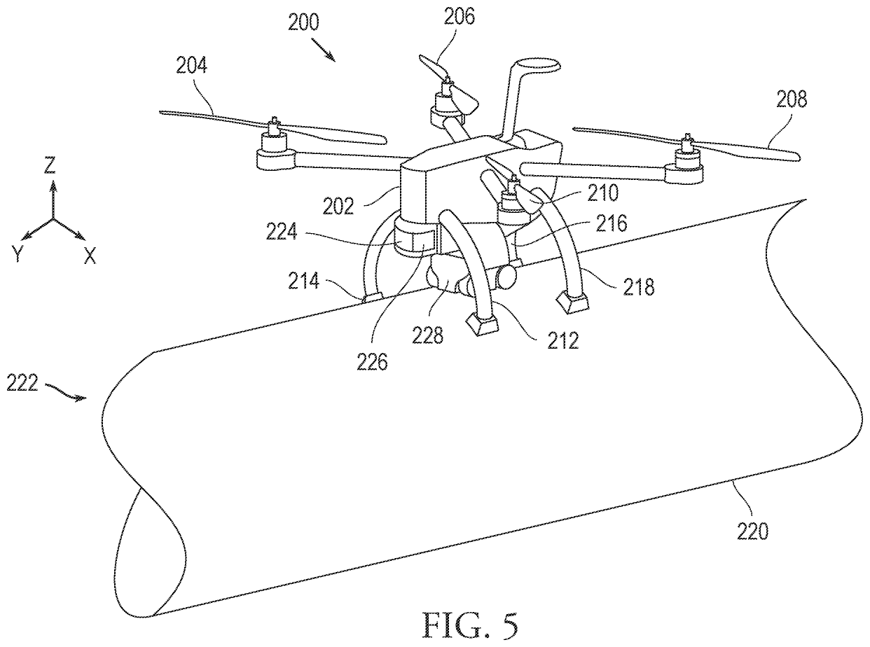

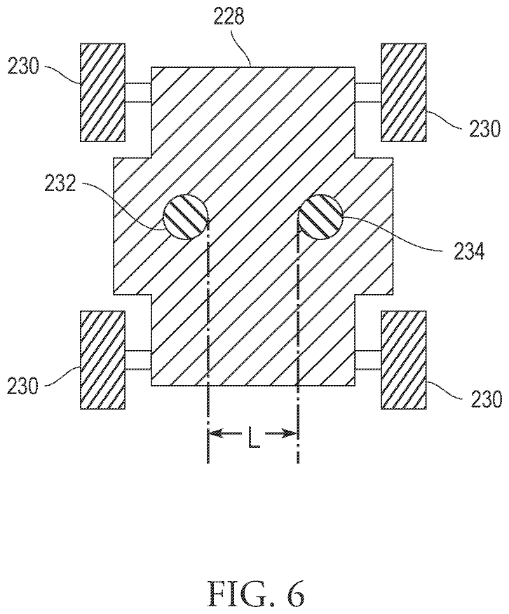

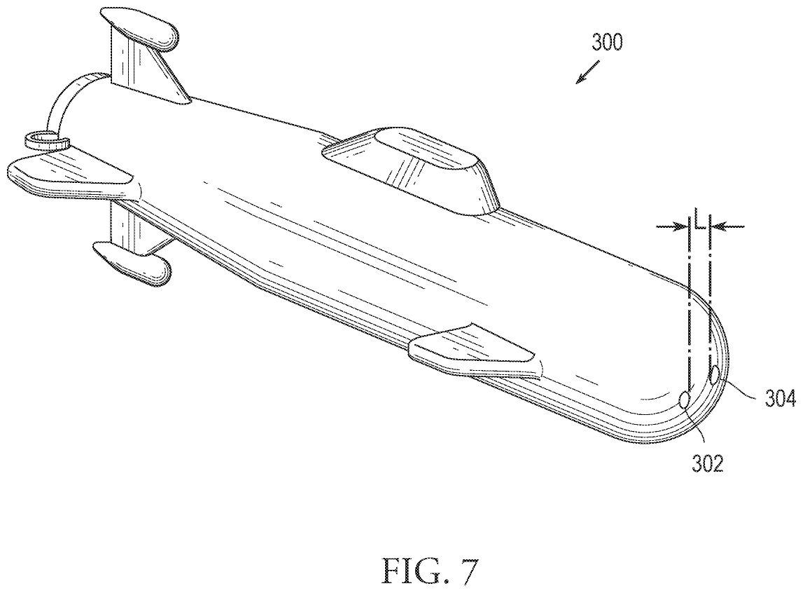

Referring to FIG. 1, a mobile device 10 includes a processor 12 including code executed therein, a memory 14, a mobile device controller 16, a first transducer 18, and a second transducer 20. The mobile device 10 is positioned in the vicinity of an object 22. The mobile device 10 can be any known type of apparatus capable of moving in space in relation to objects such as the object 22. In one embodiment, shown in FIG. 1, the mobile device 10 includes a mobile device controller 16 configured to control the movement of the mobile device 10. As described herein, for example, the mobile device 10 can be an autonomous downhole robot 100 shown in FIGS. 3-4, an unmanned aerial vehicle (UAV) 200 shown in FIGS. 5-6, or a submarine 300 shown in FIG. 7. In an alternative embodiment, shown in FIG. 2, a mobile device 50 is operatively connected to an external controller 52. For example, the mobile device 50 can be a semi-autonomous downhole robot connected to a tether which is, in turn, connected to the external controller 52 located on the surface of the Earth.

The transducers 18, 20 are disposed in the mobile device 10. For example, the mobile device 10 can have a housing or chassis 28 with apertures. The transducers 18, 20 are exposed to the external environment through the apertures. The first transducer 18, labelled A, has a distance D1 from the emitting end 24 thereof to the object 22. The second transducer 20, labelled B, has a distance D2 from the emitting end 26 thereof to the object 22. The emitting end 26 of the second transducer 20 is physically offset in a first direction from the emitting end 24 by a predetermined offset distance Δd>0. The first direction can be a direction of motion of the mobile device 10. Alternatively, the first direction can be a direction parallel to a longitudinal axis of the mobile device 10. The offset distance Δd=|D1−D2|, which is the absolute value of the difference of the distances D1, D2. In an example embodiment Δd=10 mm. As shown in FIG. 1, for example, D1>D2. However, in an alternative embodiment, without loss of generality, the transducers 18, 20 can be disposed in the mobile device 10 with the transducers 18, 20 positioned relative to each other along the first direction, with D2>D1.

Referring to FIGS. 3-4, in one embodiment of the mobile devices 10, 50, an autonomous downhole robot 100 has a plurality of modules 112, 114, 116, 118 configured to move in the first direction 120. The module 112 can be a sensor or navigation module having the physically offset transducers 18, 20 shown in FIGS. 1-2. The modules 114, 118 can be drive modules having treads 128. The treads 128 can be extended out of or retracted into the respective drive modules 114, 118. The module 116 can be a computing module having the processor 12, memory 14, and the controller 16 shown in FIGS. 1-2. The autonomous downhole robot 100 can be a robotically actuated two degree-of-freedom (2-DOF) downhole tool used for scanning and generating 3D point clouds of the internal well geometry while being deployed in a highly variable flowing well environment.

Referring to FIG. 4, the front end of the navigation module 112 is shown. The end sections 24, 26 of the transducers 18, 20, respectively, are exposed to transmit and receive sound. The end sections 24, 26 are spaced apart laterally by a lateral length L extending in a second direction perpendicular to the first direction 120. The first direction 120 can be a longitudinal axis of the autonomous downhole robot 100. The length L can be relatively small, for example, between 5 mm. and 10 mm. to measure the distances within a wellbore.

Referring to FIGS. 5-6, in an alternative embodiment of the mobile devices 10, 50, a UAV 200 has a chassis 202 from which extend a plurality of rotors 204, 206, 208, 210, and a plurality of legs 212, 214, 216, 218. The UAV 200 is configured to fly to, hover over, perch on, and take off from a surface 220 of a structure 222. A first pair of physically offset transducers 224, 226 can be disposed in the chassis 202, with the transducers 224, 226 configured to detect objects in the X-Y plane in which the UAV 200 travels. As shown in FIGS. 5-6, the UAV 200 can also have a base 228 having feet 230 on the ends of the legs 212, 214, 216, 218. The UAV 200 also includes a second pair of physically offset transducer 232, 234 configured to detect objects in the Z-direction, such as the surface 220. As described above, the lateral length L between the transducers 232, 234 can be 10 mm. Referring to FIG. 7, in an additional alternative embodiment, the mobile devices 10, 50 can be a submarine 300 having at least a pair of physically offset transducers 302, 304, with a lateral length L between the transducers 302, 304. Typically, submarines encounter relatively large objects while underwater, so the lateral length L for a submarine 300 can be on the order of meters, such as 1 m. It is to be understood that the lateral length L between transducers of any mobile device can be determined by the overall size of the mobile device as well as the approximate size of objects that the mobile device can encounter while in motion.

As shown by the arrows in FIGS. 1-2 between the transducers 18, 20 and the object 22, the transducers 18, 20 transmit and receive sounds. In one embodiment, the transducers 18, 20 transmit and receive ultrasound. In an alternative embodiment, the transducers 18, 20 can transmit and receive sounds of any wavelength or frequency. For example, the first transducer 18 can transmit sounds with a center frequency of 1 MHZ, and the second transducer 20 can transmit sounds with a center frequency of 4 MHZ. One advantage of using different center frequencies transmitted by the transducers 18, 20 is that different center frequencies reduce or eliminate cross-talk or sonic interference involving such transducers 18, 20. The transducers 18, 20 can transmit at different center frequencies. In an alternative embodiment, the transducers 18, 20 can transmit at the same center frequency.

Referring again to FIGS. 1-2, the first transducer 18, under the control of the processor 12, can transmit a first sonic pulse in the first direction towards the object 22. The first transducer 18 can receive a first echo of the first sonic pulse from the object 22. The first transducer 18 can generate a first time-of-flight value A of the first sonic pulse. The first transducer 18 can transmit the first time-of-flight value A to the processor 12. Similarly, the second transducer 20, under the control of the processor 12, transmits a second sonic pulse in the first direction towards the object 22. The second transducer 20 can receive a second echo of the second sonic pulse from the object 22. The second transducer 20 can generate a second time-of-flight value B of the second sonic pulse, and the second transducer 20 transmits the second time-of-flight value B to the processor 12.

The processor 12 receives the first time-of-flight value A and the second time-of-flight value B, and generates a speed-of-sound value S from the first time-of-flight value A, the second time-of-flight value B, and the offset distance Δd according to S=Δd/|A−B|. The speed-of-sound value S corresponds to the speed of sound in a medium of the environment through which the mobile device 10 is positioned or moving. The processor 12 determines a distance value D of the object 22 from at least one of the first and second transducers 18, 20 using the speed-of-sound value S and at least one of the first time-of-flight value A and the second time-of-flight value B, respectively. For example, the distance D is determined by the processor 12 according to D=S×A, when A>B. When A>B, the distance D=D1=D2+Δd. Alternatively, the distance D is determined by the processor 12 according to D=S×B, when B>A. When B>A, the distance D=D2=D1+Δd. The memory 14 is configured to store such values, including the first time-of-flight value A, the second time-of-flight value B, the offset distance Δd, the speed-of-sound value S, and the distance D.

The processor 12 can transmit the distance value D to the mobile device controller 16 or to the external controller 52 shown in FIGS. 1-2, respectively. In response to the distance value D, the mobile device controller 16 or the external controller 52 can generate a control signal from the distance value D, representing the distance of the mobile device 10 to the object 22. In response to the control signal, the mobile device controller 16 or the external controller 52 can control movement of the mobile device 10. For example, the mobile device 10 can include a propulsion subsystem 30. In response to the control signal, the propulsion subsystem 30 can move the mobile device 10 toward the object 22, away from the object 22, or around the object 22, or stay at a fixed distance from the object 22, depending on the circumstances of the mobile device and the object 22. For example, using the determined distance D, the autonomous downhole robot 100 in FIGS. 3-4 can detect an object 22 in the path of the robot 100. The robot 100 can then approach the object 22 in the first direction, retreat from the object 22, go around the object 22, or stop to stay at a fixed distance from the object 22. Since the autonomous downhole robot 100 can move through wellbores with natural gas, petroleum, or other gaseous or liquid media, the mobile device 10 embodied as the robot 100 is capable of determining the local speed of sound, and then to determine the distance D accurately to perform such maneuvers.

Similarly, using the determined distance D, the UAV 200 in FIGS. 5-6 can approach a surface 220 of a structure 222, perch or land on the surface 220, hover at a fixed distance from the surface 220 of the structure 222, or fly away from the surface 220. Since the UAV 200 can move through the air or in other gaseous media near the surface 220 of the structure 222, the mobile device 10 embodied as the UAV 200 is capable of determining the local speed of sound, and then to determine the distance D accurately to perform such maneuvers. In further embodiments, using the determined distance D, a submarine 300 shown in FIG. 7 can move in any direction under water, depending on the orientation of the transducers 302, 304 pointing in a select direction. Since a submarine can travel in seawater or fresh water, the local speed of sound can vary. Accordingly, the mobile device 10 embodied as the submarine 300 is capable of determining the local speed of sound, and then to determine the distance D accurately to perform such maneuvers.

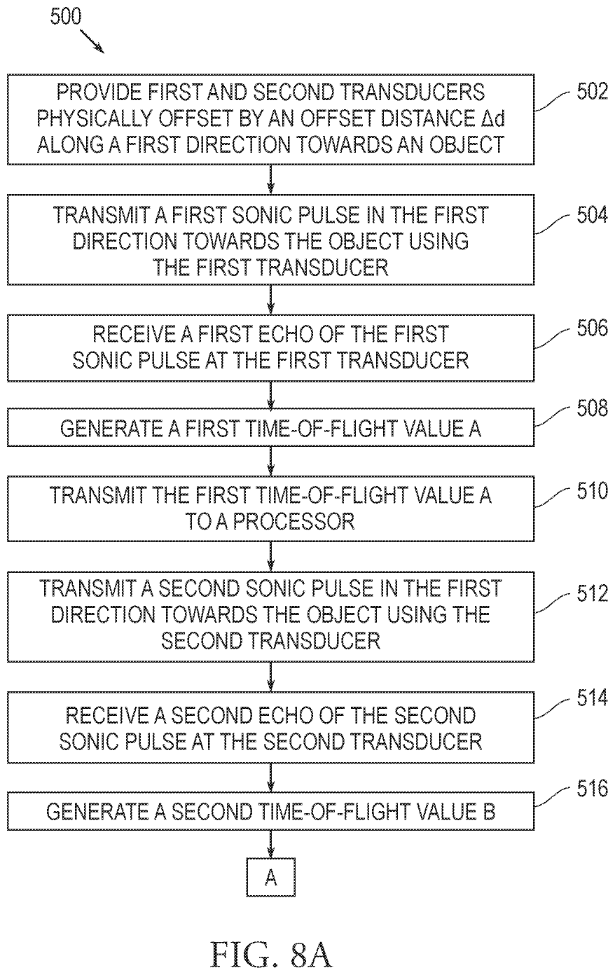

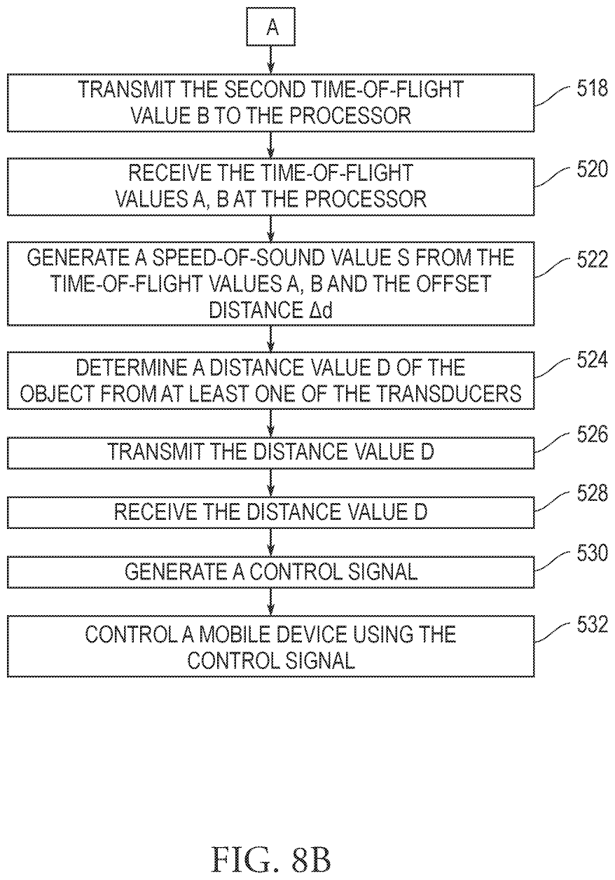

As shown in FIGS. 8A-8B, a method 500 of operation of the system using physically offset transducers involves providing such physically offset transducers in step 502, with the transducers physically offset by a predetermined offset distance Δd in a first direction towards an object 22, as shown in FIGS. 1-2. In step 504, the first transducer 18, under the control of the processor 12, transmits a first sonic pulse in the first direction towards the object 22. The first transducer 18 can receive a first echo of the first sonic pulse from the object 22 in step 506. The first transducer 18 can generate a first time-of-flight value A of the first sonic pulse in step 508. The first transducer 18 can transmit the first time-of-flight value A to the processor 12 in step 510. Similarly, the second transducer 20, under the control of the processor 12, transmits a second sonic pulse in the first direction towards the object 22 in step 512. The second transducer 20 can receive a second echo of the second sonic pulse from the object 22 in step 514. The second transducer 20 can generate a second time-of-flight value B of the second sonic pulse in step 516, and the second transducer 20 transmits the second time-of-flight value B to the processor 12 in step 518.

In step 520, the processor 12 receives the first time-of-flight value A and the second time-of-flight value B, and generates a speed-of-sound value S from the first time-of-flight value A, the second time-of-flight value B, and the offset distance Δd in step 522. The speed-of-sound value S is determined according to S=Δd/|A−B|. The speed-of-sound value S corresponds to the speed of sound in a medium of the environment in which the mobile device 10 is positioned or moving. In step 524, the processor 12 determines a distance value D of the object 22 from at least one of the first and second transducers 18, 20 using the speed-of-sound value S and at least one of the first time-of-flight value A and the second time-of-flight value B, respectively. For example, the distance D is determined by the processor 12 according to D=S×A, when A>B. When A>B, the distance D=D1=D2+Δd. Alternatively, the distance D is determined by the processor 12 according to D=S×B, when B>A. When B>A, the distance D=D2=D1+Δd. The memory 14 is configured to store such values, including the first time-of-flight value A, the second time-of-flight value B, the offset distance Δd, the speed-of-sound value S, and the distance D.

The processor 12 can transmit the distance value D to the mobile device controller 16 in step 526, and the mobile device controller 16 receives the distance value D in step 528. In response to the distance value D, in step 530 the mobile device controller 16 can generate a control signal from the distance value D, representing the distance of the mobile device 10 to the object 22. In response to the control signal, the mobile device controller 16 can control the mobile device 10 using the control signal in step 532. The control of the mobile device 10 can include controlling movement of the mobile device 10.

In alternative embodiments, a plurality of physically offset transducers, such as three or more transducers emitting sound in a common first direction, can be used to increase the accuracy of the determination of the local speed of sound, and in turn can increase the accuracy of the determination of distance of the transducers from an object. In additional embodiments, a plurality of physically offset transducers can be used in any known apparatus which is mobile, semi-mobile, fixable to the ground or to a structure, or fixed to the ground, with the apparatus configured to determine distance. For example, ground surveying equipment can use such physically offset transducers to determine distances to objects, such as markers or landmarks. Accordingly, triangulation involving multiple sensors at different locations can be replaced by only two physically offset transducers spaced apart by a relatively small lateral direction L, as shown in FIGS. 4 and 6-7, with the predetermined offset distance Δd between the physically offset transducers extending in a first direction towards an object.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including.” “comprising.” “having.” “containing,” “involving.” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system, comprising:
a first transducer configured to transmit a first sonic pulse in a first direction towards an object, to receive a first echo of the first sonic pulse from the object, and to generate a first time-of-flight value A of the first sonic pulse;
a second transducer configured to transmit a second sonic pulse in the first direction towards the object, to receive a second echo of the second sonic pulse from the object, and to generate a second time-of-flight value B of the second sonic pulse, wherein the second transducer is physically offset from the first transducer by an offset distance Δd along the first direction;
a processor including code executed therein configured to receive the first time-of-flight value A and the second time-of-flight value B, to generate a speed-of-sound value S, and to determine a distance value D of the object from at least one of the first and second transducers using the speed-of-sound value S and at least one of the first time-of-flight value A and the second time-of-flight value B, respectively; and
a controller configured to receive the distance value D, and responsive to the distance value D to generate a control signal to control movement of a mobile device.

2. The system of claim 1, wherein the mobile device includes the controller.

3. The system of claim 1, wherein the controller is external to the mobile device.

4. The system of claim 1, wherein the speed-of-sound value S corresponds to the speed of sound of a medium in an environment of the mobile device.

5. The system of claim 1, wherein the processor is configured to determine the speed-of-sound value S according to S=—Δd/|A—B|,
wherein the value |A−B| is the absolute value of a difference of the first time-of-flight value A and the second time-of-flight value B.

6. The system of claim 1, wherein the processor is configured to determine the distance D according to D=S×A, wherein A>B.

7. The system of claim 1, wherein the processor is configured to determine the distance D according to D=S×B, wherein B>A.

8. The system of claim 1, wherein the first and second transducers are spaced apart by a length L in a second direction perpendicular to the first direction.

9. A mobile device, comprising:
a chassis;
a propulsion subsystem having an end section and configured, responsive to a control signal, to propel the chassis in a first direction;
a first transducer disposed in the end section and configured to transmit a first sonic pulse in a first direction towards an object, to receive a first echo of the first sonic pulse from the object, and to generate a first time-of-flight value A of the first sonic pulse;
a second transducer disposed in the end section configured to transmit a second sonic pulse in the first direction towards the object, to receive a second echo of the second sonic pulse from the object, and to generate a second time-of-flight value B of the second sonic pulse, wherein the second transducer is physically offset from the first transducer by an offset distance Δd along the first direction; and
a processor including code executed therein configured to receive the first time-of-flight value A and the second time-of-flight value B, to generate a speed-of-sound value S, and to determine a distance value D of the object from at least one of the first and second transducers using the speed-of-sound value S and at least one of the first time-of-flight value A and the second time-of-flight value B, respectively,
wherein a controller is configured to receive the distance value D, and is responsive to the distance value D to generate the control signal to control movement of a mobile device by the propulsion subsystem.

10. The mobile device of claim 9, wherein the chassis includes the controller.

11. The mobile device of claim 9, wherein the controller is external to the chassis.

12. The mobile device of claim 9, wherein the speed-of-sound value S corresponds to the speed of sound of a medium in an environment of the mobile device.

13. The mobile device of claim 9, wherein the processor is configured to determine the speed-of-sound value S according to S=Δd/|A−B|,
wherein the value |A−B| is the absolute value of a difference of the first time-of-flight value A and the second time-of-flight value B.

14. The mobile device of claim 9, wherein the processor is configured to determine the distance D according to D=S×A, wherein A>B.

15. The mobile device of claim 9, wherein the processor is configured to determine the distance D according to D=S×B, wherein B>A.

16. The mobile device of claim 9, wherein the first and second transducers are spaced apart in the end section by a length L in a second direction perpendicular to the first direction.

17. A method, comprising:
providing a processor, a first transducer, and a second transducer physically offset from the first transducer by an offset distance Δd along a first direction;
transmitting a first sonic pulse in the first direction towards an object using the first transducer;
receiving a first echo of the first sonic pulse from the object at the first transducer;
generating a first time-of-flight value A of the first sonic pulse using the first transducer;
transmitting the first time-of-flight value A to the processor;
transmitting a second sonic pulse in the first direction towards the object using the second transducer;
receiving a second echo of the second sonic pulse from the object at the second transducer;
generating a second time-of-flight value B of the second sonic pulse using the second transducer;
transmitting the second time-of-flight value B to the processor;
receiving the first time-of-flight value A and the second time-of-flight value B at the processor;
generating a speed-of-sound value S from the first time-of-flight value A, the second time-of-flight value B, and the offset distance Δd;
determining a distance value D of the object from at least one of the first and second transducers using the speed-of-sound value S and at least one of the first time-of-flight value A and the second time-of-flight value B, respectively;
receiving the distance value D at a controller;
responsive to the distance value D, generating a control signal using the controller; and
responsive to the control signal, controlling movement of a mobile device.

18. The method of claim 17, wherein the speed-of-sound value S corresponds to the speed of sound of a medium in an environment of the mobile device.

19. The method of claim 17, wherein determining a distance value D of the object further comprises determining the distance value D according to S=Δd/|A−B|,
wherein the value |A−B| is the absolute value of a difference of the first time-of-flight value A and the second time-of-flight value B.

20. The method of claim 17, wherein the mobile device includes the processor, the first transducer, and the second transducer.
